(19) United States
(12) Patent Application Publication
(10) Pub. No.: US 2026/0116420 A1
(43) Pub. Date: Apr. 30, 2026

(54) VEHICLE EVENT DETECTION BASED ON LEVEL OF COMPLEXITY OF EVENTS

(71) Applicant: International Business Machines Corporation, Armonk, NY (US)

(72) Inventors: Bo Chen ZHU, Xi'an (CN); Xinzhe WANG, Beijing (CN); Chu Yan PENG, Beijing (CN)

(21) Appl. No.: 18/934,197

(22) Filed: Oct. 31, 2024

(51) Int. Cl. B60W 60/00; H04L 12/40

(52) U.S. Cl. CPC B60W 60/001; H04L 12/40; H04L 2012/40273

(57) ABSTRACT

In some implementations, a system may receive a signal from a sensor of a machine. The system may determine a level of complexity, associated with the signal, from different levels of complexity of events occurring during an operation of the machine, wherein the different levels of complexity include: a first level of complexity associated with a single threshold, a second level of complexity associated with a plurality of thresholds, and a third level of complexity associated with weighted signals. The system may process the signal based on the level of complexity. The system may detect an event based on processing the signal based on the level of complexity. The system may provide an indication that the event has been detected to one or more components of the machine to cause the one or more components to control an operation of the machine.

### BACKGROUND

The present invention relates to vehicles, and more particularly to the field of detecting events occurring as a result of operating the vehicles.

A vehicle is any motorized vehicle that is capable of transporting one or more passengers from an origin location to a destination. The vehicle may include a manned vehicle, a semiautonomous vehicle, or an autonomous vehicle. A manned vehicle operates with input from a human operator. An autonomous vehicle is capable of operating with reduced input from a human operator or capable of operating without input from a human operator. A semiautonomous vehicle is capable of operating with reduced input from a human operator.

### SUMMARY

In some implementations, a method includes receiving a signal from a sensor of a machine; determining a level of complexity, of events associated with the signal, from different levels of complexity of events occurring during an operation of the machine, wherein the different levels of complexity include: a first level of complexity associated with a single threshold, a second level of complexity associated with a plurality of thresholds, and a third level of complexity associated with weighted signals; processing the signal based on the level of complexity; detecting an event based on processing the signal based on the level of complexity; and providing an indication that the event has been detected to one or more components of the machine to cause the one or more components to control an operation of the machine.

In some implementations, a system comprising: an event analyzer to generate information regarding different levels of complexity of different events, wherein the different levels of complexity include: a first level of complexity associated with a single threshold, a second level of complexity associated with a plurality of thresholds, and a third level of complexity associated with weighted signals; a sensor to: generate a signal, determine whether a level of complexity of events, associated with the signal, is the first level of complexity; process the signal based on the first level of complexity to determine whether a first event associated with the first level of complexity is detected; and a signal bus to: determine whether the level of complexity is the second level of complexity or the third level of complexity, and provide the signal to be processed based on: the second level of complexity to determine whether a second event associated with the second level of complexity is detected, or the third level of complexity to determine whether a third event associated with the third level of complexity is detected.

In some implementations, a computer program product comprising: one or more computer-readable storage media; and program instructions stored on the one or more computer readable storage media to perform comprising: receiving a signal from a sensor of a machine; determining a level of complexity, of events associated with the signal, from different levels of complexity of events occurring during an operation of the machine, wherein the different levels of complexity include: a first level of complexity associated with a single threshold, a second level of complexity associated with a plurality of thresholds, and a third level of complexity associated with weighted signals; processing the signal based on the level of complexity; detecting an event based on processing the signal based on the level of complexity; and providing an indication that the event has been detected to one or more components of the machine to cause the one or more components to control an operation of the machine.

### BRIEF DESCRIPTION OF THE DRAWINGS

FIG. 1-8 are diagram of example implementations described herein.

FIG. 9 is a diagram of an example computing environment in which systems and/or methods described herein may be implemented.

FIG. 10 is a diagram of example components of one or more devices of FIG. 1.

FIG. 11 is a flowchart of an example process associated with detecting events of vehicles.

### DETAILED DESCRIPTION

The following detailed description of example implementations refers to the accompanying drawings. The same reference numbers in different drawings may identify the same or similar elements.

An intelligent driving system is a system, included in a vehicle, that uses sensors to detect objects and errors and that makes decisions responsive to the objects and errors. The sensors may include cameras, LiDAR devices, speed sensors, among other examples. The intelligent driving system may update a driver, of the vehicle, of objects in a complex environment surrounding the vehicle.

In an intelligent driving system, a single sensor cannot meet the requirement of sensing a complex environment surrounding the vehicle. Thus, multiple sensors are utilized to work cooperatively to sense the complex environment (e.g., to detect objects). The intelligent driving system may include a sensor data fusion module (or “fusion module) that may be used to synthesize data from the multiple sensors.

The synthesized data may provide a more accurate and trustworthy basis for complex event detection for the vehicle and for decision-making based on the complex event detection. For example, the synthesized data may be used to detect events that occur during an operation of the vehicle, such as speeding, detecting an object, detecting a speed limit. The fusion module may use resources of the intelligent driving system to synthesize the data.

Data fusion may be subjected to technical problems. For example, the fusion module may consume additional resources to perform data processing on raw sensor data, such as to perform time synchronization, filtering out noise, applying data fusion algorithms, and so on. By consuming the additional resources, performing the data processing may (in some situations) result in delayed event detection. Accordingly, data fusion may be subjected to the technical problem of delayed event detection.

In addition to the delayed event detection (e.g., detection of events), the fusion module may be subjected to the technical problem of detection reliability. For example, a failure of time servers may result in time synchronization deviations. For example, sensor data from two mor more sensors may be used to detect a particular event. However, the time synchronization deviations may cause the sensor data to be provided at different times. As a result of the sensor data being provided at different times, the particular event may be detected late, may not be detected, or may be erroneously detected.

Accordingly, the time synchronization deviations may affect the accuracy and reliability of the fusion results. In this regard, the accuracy and reliability may result in inaccurate event detection. The delayed event detection and inaccurate event detection may seriously affect the decision-making process of the intelligent driving system. Additionally, the delayed event detection and inaccurate event detection may affect the control capabilities of the intelligent driving system (e.g., the capabilities to control an operation of the vehicle).

Accordingly, there is a need for some event detection to occur prior to data fusion of the sensor data from the multiple sensors. In other words, there is a need to detect some events prior to the data fusion being performed on the sensor data.

Implementations described herein are directed to detecting events in early stage for a vehicle system (e.g., an automobile system). The events may be detected using signals from different sensors. As used herein, “early stage” may refer to prior to data fusion being performed on the signals (e.g., sensor data).

Implementations described herein are directed to a detection system that includes an event analyzer, sensors, a signal bus, and different detection modules. In some examples, the event analyzer may generate rules that identify different levels of complexity for events occurring during an operation of the vehicle. In some examples, the rules may be used to identify four levels of complexity according to different levels of complexity for detecting the events.

In some implementations, the rules may be implemented as filters that are implemented on processors of the sensors and on the signal bus. In some examples, the filters may include information identifying different sensors for different levels of complexity. The signals may include information identifying the sensors that provided the signals. In this regard, based on the information included in the signals, the filters may identify a level of complexity associated with the signals.

As an example, a first filter may be implemented on the processor of the sensor. A second filter and a third filter may be implemented on the signal bus. The first filter may be used to detect signals associated with events of a first level of complexity. The first level of complexity may identify events that may be detected using a single threshold, such as a speed threshold.

The second filter may be used to detect signals associated with events of a second level of complexity. The second level of complexity may identify events that may be detected using a combination of threshold, such as a speed threshold and a distance threshold (e.g., a distance between an object and the vehicle).

The third filter may be used to detect signals associated with events of a third level of complexity. The third level of complexity may identify events that may be detected using a combination of weighted signals.

The filters may be used to filter the signals (e.g., the sensor data) for each level of complexity of events. Signals associated with the second level of complexity may be stored in a data structure of a first type and the third level of complexity may be stored in a data structure of a second type. The data structures (or information stored in the data structures) may be analyzed to detect events before data fusion is performed. By filtering the signals and analyzing the data structures, events may be detected and reported to one or more components that control an operation of the vehicle.

Implementations described herein are directed to detecting events in early stage to help the automobile system make fast and accurate decisions. Implementations described herein may separate events according to different levels of complexity. Implementations described herein may generate the filter for the related data of different event levels. Implementations described herein are directed to a quick way for events detection (e.g., for detecting events).

Event detection (performed prior to data fusion) may be used as a complementary process to current event detection methods. In this regard, performing event detection (prior to data fusion) may effectively help intelligent driving systems make fast and accurate decisions.

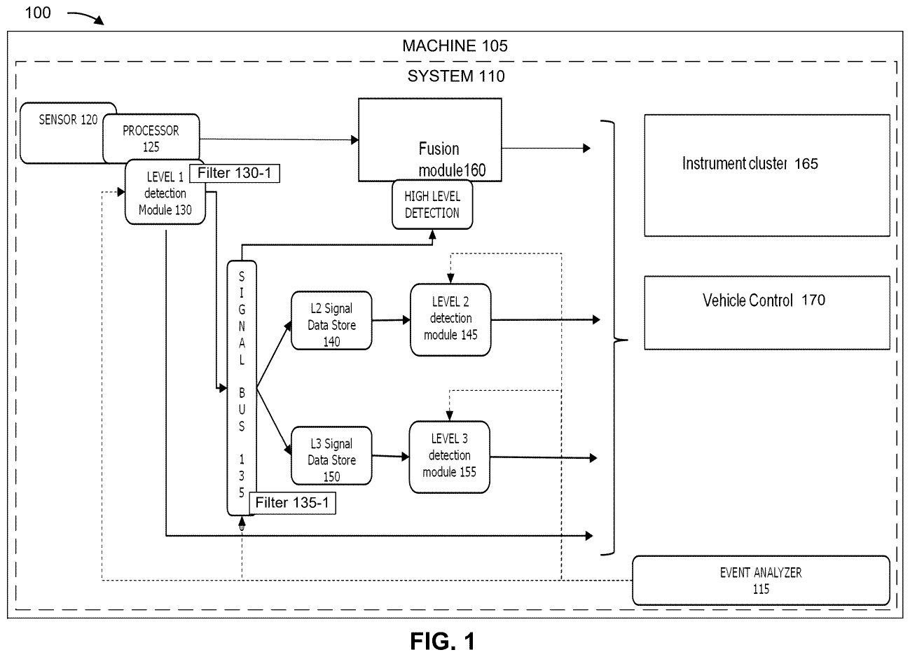

FIG. 1 is a diagram of an example implementation 100 described herein. As shown in FIG. 1, implementation 100 may include a machine 105. In some examples, machine 105 may be a vehicle, such as a manned vehicle, a semiautonomous vehicle, or an autonomous vehicle. As shown in FIG. 1, machine 105 may include a system 110. System 110 may be an intelligent driving system.

As shown in FIG. 1, system 110 may include multiple components, such as an event analyzer 115, a sensor 120, a signal bus 135, a L2 (level 2) signal data store 140, a level 2 detection module 145, a L3 (level 3) signal data store 150, a level 3 detection module 155, a fusion module 160, an instrument cluster 165, a vehicle control 170.

Event analyzer 115 may include one or more components that generate rules that identify different levels of complexity of events. In some implementations, event analyzer 115 may analyze historical data regarding events detected during an operation of machine 105 and may generate the rules based on analyzing the historical data regarding events that have been detected. The historical data may include data of an existing event detection model.

In some implementations, the historical data may identify individual sensors that provide signals that cause events to be detected. For example, the historical data may identify a first sensor that generates a signal that cause a first event to be detected, identify a second sensor that generates a signal that cause a second event to be detected, and so on. The historical data may identify groups of sensors that provide signals that individually cause events to be detected. For example, the historical data may identify a first group of sensors that generate signals that cause a third event to be detected, identify a second group of sensors that generate signals that cause a fourth event to be detected, and so on.

By the analysis of the existing event detection model, event analyzer 115 may generate one or more rules for each level of complexity of events. In some examples, event analyzer 115 may generate rules for four different levels of complexity. The levels of complexity may include a first level of complexity. The first level of complexity may include events that may be detected using a single threshold and a single signal. For example, a speed event may be detected if a value of a signal (from a speed sensor) exceeds a speed threshold.

The levels of complexity may include a second level of complexity. The second level of complexity may include events that may be detected using multiple thresholds and multiple signals. For example, a collision prevention event may be detected if a value of a signal (from a speed sensor) indicates a speed that exceeds a speed threshold and if a value of a signal (from a LiDAR) indicates a distance (to an object) that is less than a distance threshold.

The levels of complexity may include a third level of complexity. The third level of complexity may include events that may be detected using multiple weighted signals (e.g., a combination of weighted signals). For example, a collision prevention event may be detected based on a signal from a speed sensor and a signal from a sensor perceiving a speed of an object.

The signal from the speed sensor may indicate a speed of machine 105. In some situations, because the speed of machine 105 may be more constant than the speed of the object (or because the speed of the object may vary more than the speed of machine 105), the signal from the speed sensor may be associated with a weight that exceeds a weight associated with the speed of the object. The collision prevent event may be detected based on a combination of weighting the signal from the speed sensor and weighting the signal from the LiDAR.

The levels of complexity may include a fourth level of complexity. The fourth level of complexity may include events that are mathematically complex to determine. Events with the fourth level of complexity may be processed by fusion module 160.

Sensor 120 may include a speed sensor, an acceleration sensor, a camera, a LiDAR device, a radar, among other examples of sensor devices that may be used in a vehicle. System 110 may include multiple sensors 120. As shown in FIG. 1, sensor 120 may include a level 1 detection module 130 and a filter 130-1. Level 1 detection module 130 may include one or more components that detect events of the first level of complexity. As an example, level 1 detection module 130 may detect when a signal satisfies a threshold and may detect that an event based on the signal satisfying the threshold. In some implementations, level 1 detection module 130 may include information identifying different thresholds for different signals.

Filter 130-1 may identify first signals that are associated with the first level of complexity. In some implementations, filter 130-1 may include first filter information identifying different sensors that generate the first signals. The first signals may include first signal information (e.g., metadata) identifying the sensors that provided the first signals. In this regard, filter 130-1 may identify the first signals associated with the first level of complexity based on the first signal information identifying the sensors included in the first signals. For example, filter 130-1 may compare the first filter information and the first sensor information identifying the sensors included in the first signals.

Signal bus 135 may include a component that enables wired and/or wireless communication among components of system 110. Signal bus 135 may receive signals from sensor 120 and/or additional sensors. As shown in FIG. 1, signal bus 135 may include a filter 135-1. Filter 135-1 may identify signals associated with the second level of complexity and signals associated with the third level of complexity. In some implementations, filter 135-1 may include second filter information identifying different sensors that generate signals associated with the second level of complexity and third filter information identifying different sensors that generate signals associated with the third level of complexity.

Filter 135-1 may identify second signals associated with the second level of complexity and identify third signals associated with the third level of complexity in manner similar to the manner described in connection with filter 130-1. Filter 135-1 may receive signals generated by sensor 120 (and/or receive copies of the signal) from sensor 120. After filter 135-1 identifies the second signals and the third signals, signal bus 135 may provide the second signals to L2 signal data store 140 and provide the third signals to L3 signal data store 150.

L2 signal data store 140 may include a data store that stores data structures storing information regarding the second signals. The information, stored in L2 signal data store 140, may be used to determine whether an event with the second level of complexity has been detected. L3 signal data store 150 may include a data store that stores data structures storing information regarding the third signals. The information, stored in L3 signal data store 150, may be used to determine whether an event with the third level of complexity has been detected.

Level 2 detection module 145 may include a component that determines whether an event associated with the second level of complexity has been detected. As explained herein, level 2 detection module 145 may use information (in L2 signal data store 140) to determine whether the event has been detected. Level 2 detection module 145 may provide an indication that the event has been detected.

Level 3 detection module 155 may include a component that determines whether an event associated with the third level of complexity has been detected. As explained herein, level 3 detection module 155 may use information (in L3 signal data store 150) to determine whether the event has been detected. Level 3 detection module 155 may provide an indication that the event has been detected.

Fusion module 160 may include one or more components that perform a data fusion operation on sensor data (e.g., signals) received from different sensors. Fusion module 160 may perform the data fusion operation to determine whether an event of the fourth level of complexity has been detected.

Instrument cluster 165 may include warning indicators (e.g., lights), dials, and gauges that provide information regarding an operation status of machine 105. For example, based on an indication that an event has been detected, instrument cluster 165 may output information regarding the event using the indicators, the dials, and/or the gauges.

Vehicle control 170 may include one or more components that control an operation of machine 105. For example, vehicle control 170 may include components that control other components of machine 105. For example, vehicle control 170 may control an engine (e.g., an engine controller), a transmission, brakes, a steering wheel, airbags, a suspension, among other examples. For instance, based on an indication that an event has been detected, vehicle control 170 may derate an engine, may change/shift from one gear to another gear, may apply the brakes to safely bring machine 105 to a stop, among other examples.

Instrument cluster 165 and vehicle control 170 may form components that control an operation of machine 105. For example, instrument cluster 165 and vehicle control 170 may adjust an operation of machine 105 based on the indications from level 2 detection module 145 and/or level 3 detection module 155.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

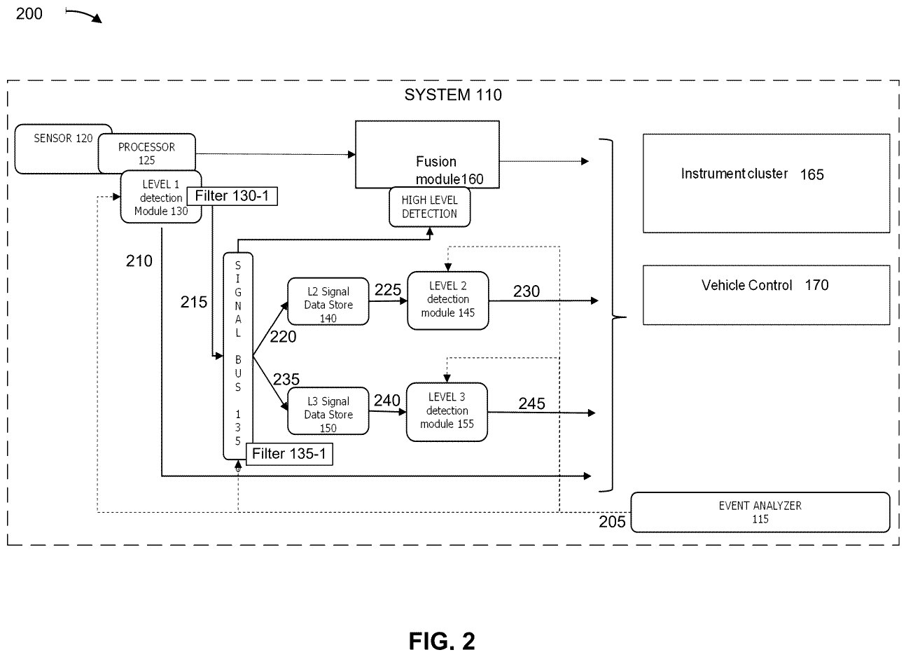

FIG. 2 is a diagram of an example implementation 200 described herein. Implementation 200 describes a process that may be implemented by system 110. In some examples, pre-processed sensor data (from different sensors including sensor 120) may be passed to fusion module 160 for higher-level processing, such as time synchronization, applying data fusion algorithms, data sharing, and so on. In fusion module 160, the pre-processed data (from the different sensors) may be integrated to form a comprehensive and instantaneous environment perception.

Information regarding the comprehensive and instantaneous environment perception may be passed to a decision-making module (e.g., including instrument cluster 165 and vehicle control 170) to develop a safe and effective driving strategy. The information regarding the comprehensive and instantaneous environment perception may contain a status of machine 105, information about static and dynamic objects around machine 105, and possible future behavior predictions. The information may be treated as a collection of different events.

As shown in FIG. 2, and by reference number 205, event analyzer 115 may generate rules regarding the different levels of complexity. For example, event analyzer 115 may use a machine learning algorithm to analyze historical data regarding events detected during an operation of machine 105 (or of a similar machine). Based on analyzing, event analyzer 115 may define rules to separate all events into different levels of complexity, which may provide the basis for processing and analysis in the detection modules.

Events with the first level of complexity may include events with a rule that includes a threshold for the metric (or value) of a single signal, which can be listed as:

$${L}_{1} = \{ s \} where s ≶ t$$

Where L₁ represents the first level of complexity, s represents the signal, and t represents the threshold.

Events with the second level of complexity may include events with a rule that includes a combined threshold for the metric (or value) of a single signal, which can be listed as:

$${L}_{2} = \{ {s}_{1} , ... , {s}_{n} \} where {s}_{i} ≶ {t}_{i} i ∈ [ 1 , ... , n ]$$

Where L₂ represents the second level of complexity, s represents the signal, and t represents the threshold.

Events with the second level of complexity may include events with a rule that includes events with a rule that includes the weighted calculation for the metric (or value) of single signal, which can be listed as:

$${L}_{3} = \{ {s}_{1} , ... , {s}_{n} \} where {\sum }_{i = 1}^{n} {ω}_{i} {s}_{i} ≶ t$$

Where L₃ represents the third level of complexity, s represents the signal, w represents a weight, and t represents a threshold.

Events with the fourth level of complexity may include events with a rule that includes a complicated modeling calculation for the metric (or value) of a single signal. In some implementations, events with the level 1 to the level 3 of complexity may detected prior to a data fusion is performed.

Event analyzer 115 may provide the different rules to respective detection modules. For example, event analyzer 115 may provide a rule regarding the first level of complexity to level 1 detection module 130, provide a rule regarding the second level of complexity to level 2 detection module 145, and so on.

As shown in FIG. 2, and by reference number 210, level 1 detection module 130 may receive a key indicator from sensor 120. The key indicator may be identified by the rule received from event analyzer 115. The key indicator may refer to useful signals received by a sensor. The sensor may transmit multiple kinds of signals but only part of the signals may be used by the system. Level 1 detection module 130 may use filter 130-1 to determine whether the signal is associated with an event of the first level of complexity. Level 1 detection module may determine whether the event has been detected. For example, level 1 detection module may determine a speed of machine 105 exceeds a speed threshold and may detect a speed event based on determining that the speed exceeds the speed threshold.

Level 1 detection module 130 may send the signal to the decision-making module directly in the event (of the first level of complexity) has been detected. As an example, level 1 detection module 130 may send an indication that the event has been detected. The decision-making module may control (e.g., adjust) an operation of machine 105 based on the indication that the event has been detected.

As shown in FIG. 2, and by reference number 215, at the same time of level 1 detection module 130 processes the signal, level 1 detection module 130 may provide the signal to the signal bus for subsequent event detection. For example, level 1 detection module 130 may provide a copy of the signal to signal bus 135.

As shown in FIG. 2, and by reference number 220, if the signal is identified for level 2 events, signal bus 135 may provide the signal for storage in a specific data structure, such as L2 signal data store 140. For example, signal bus 135 may use filter 135-1 to identify the signal as a signal associated with events of a second level of complexity. Based on the level of complexity being the second level of complexity, signal bus 135 may provide the signal to L2 signal data store 140.

As shown in FIG. 2, and by reference number 225, the signal may be provided to level 2 detection module 145. For example, level 2 detection module 145 may obtain the signal from L2 signal data store 140 in order to determine whether an event associated with the second level of complexity has been detected.

As shown in FIG. 2, and by reference number 230, level 2 detection module 145 may obtain receive a key indicator from the signal. The key indicator may be identified by the rule received from event analyzer 115. Level 2 detection module 145 may use information from L2 signal data store to determine whether the signal is associated with an event of the second level of complexity. Level 2 detection module 145 may determine whether the event has been detected.

Level 2 detection module 145 may send the signal to the decision-making module directly in the event (of the second level of complexity) has been detected. As an example, level 2 detection module 145 may send an indication that the event has been detected. The decision-making module may control an operation of machine 105 based on the indication that the event has been detected.

As shown in FIG. 2, and by reference number 235, if the signal is identified for level 3 events, signal bus 135 may provide the signal for storage in a specific data structure, such as L3 signal data store 150. For example, signal bus 135 may use filter 135-1 to identify the signal as a signal associated with events of the third level of complexity. Based on the level of complexity being the third level of complexity, signal bus 135 may provide the signal to L3 signal data store 150.

As shown in FIG. 2, and by reference number 240, the signal may be provided to level 3 detection module 155. For example, level 3 detection module 155 may obtain the signal from L3 signal data store 150 in order to determine whether an event associated with the third level of complexity has been detected.

As shown in FIG. 2, and by reference number 245, level 3 detection module 155 may obtain receive a key indicator from the signal. The key indicator may be identified by the rule received from event analyzer 115. Level 3 detection module 155 may use information from L3 signal data store to determine whether the signal is associated with an event of the third level of complexity. Level 3 detection module 155 may determine whether the event has been detected.

Level 3 detection module 155 may send the signal to the decision-making module directly in the event (of the second level of complexity) has been detected. As an example, level 3 detection module 155 may send an indication that the event has been detected. The decision-making module may control an operation of machine 105 based on the indication that the event has been detected.

If the signal is not identified for a level 2 event or a level 3 event, the signal may be provided to a high level detection module. For example, the signal may be provided to fusion module 160. A “level 2 event” may refer to an event with the level 2 complexity. A “level 3 event” may refer to an event with the level 3 complexity.

As indicated above, FIG. 2 is provided as an example. Other examples may differ from what is described with regard to FIG. 2 of devices shown in FIG. 2 is provided as an example. There may be additional devices (e.g., a large number of devices), fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices in FIG. 2.

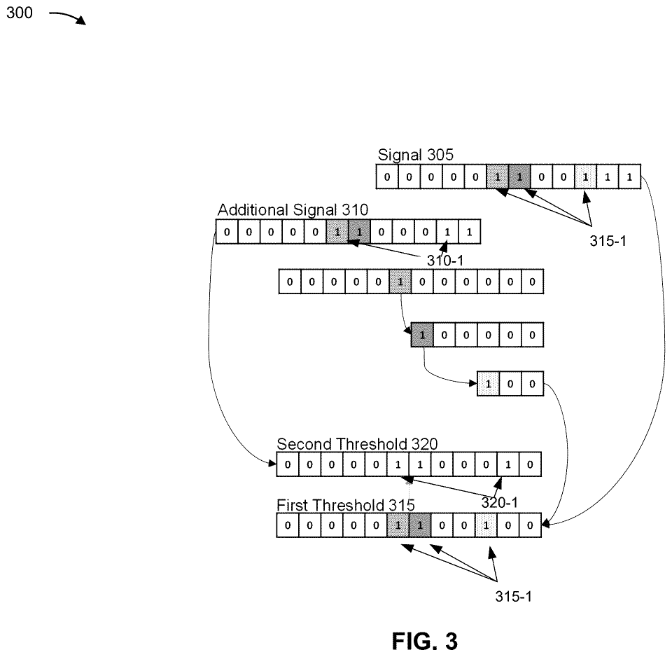

FIG. 3 is a diagram of an example implementation 300 described herein. Implementation 300 describes a process that may be implemented by system 110. For example, implementation 300 describes a process that may be implemented to detect an event of the first level of complexity.

Each event of the first level of complexity may be associated with a single threshold. In some implementations, all events (of the first level of complexity) for the same signal may be combined as a series of filters in a memory. For example, for a signal provided by the speed sensor, events may be detected as the speed of machine 105 exceed different speed thresholds indicated by different speed limits. In this regard, the different speed thresholds may be combined. For example, binary data corresponding to the different speed thresholds may be combined.

To implement the filter, the following steps needs to be done. In this example, an assumption is that the threshold condition is greater than. In other words, an event may be detected if the signal exceeds a threshold. If an event is detected if the signal is less than the threshold, the opposite filter condition will be used.

Referring back to the steps, all the thresholds (for the signal) may be sorted from high to low. The thresholds with the same highest bit may be combined together as groups. In the same group, the highest bit may be ignored. The steps of combining the thresholds and ignoring the highest bit may be repeated until every threshold has its own group. An index of a group identifier may be used to form an index. An index may be generated for all the thresholds. Refer the index and order to generate the series of filters and links. In some examples, the same signal may be associated with different events with different thresholds, or associated with the same event with different levels. The index may be used to identify an event that has been triggered. For example, level 1 detection module 130 may compare bits of the signal and bits associated with the thresholds of an index using an AND logical operation.

The filters may be implemented using logical ‘AND’ operations. If all ‘AND’ operations are fulfilled, there will be a unique threshold identified. If there is an ‘AND’ operation is not fulfilled, a filter (preceding a current filter in the current index) may be selected as the threshold. An example of using the filters is provided below.

For example, if signal 305 is being processed, signal 305 may satisfy first threshold 315. For example, asserted bits 315-1 of first threshold 315 may correspond to asserted bits 305-1 of first threshold 315.

For example, if additional signal 310 is being processed, additional signal 310 may not satisfy first threshold 315. For example, asserted bits 315-1 of first threshold 315 may not correspond to asserted bits 310-1 of secondt2threshold 315. Accordingly, level 1 detection module 130 may select a next combination of thresholds (e.g., second threshold 320). Additional signal 310 may satisfy second threshold 320. For example, asserted bits 320-1-of second threshold 320 may correspond to asserted bits 310-1 of second threshold 320. When determining whether an event has occurred, level 1 detection module 130 may determine whether bits of the signal (e.g., asserted bits) correspond to bits (e.g., asserted bits) of a combination of thresholds.

As indicated above, FIG. 3 is provided as an example. Other examples may differ from what is described with regard to FIG. 3 of devices shown in FIG. 3 is provided as an example. There may be additional devices (e.g., a large number of devices), fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices in FIG. 3.

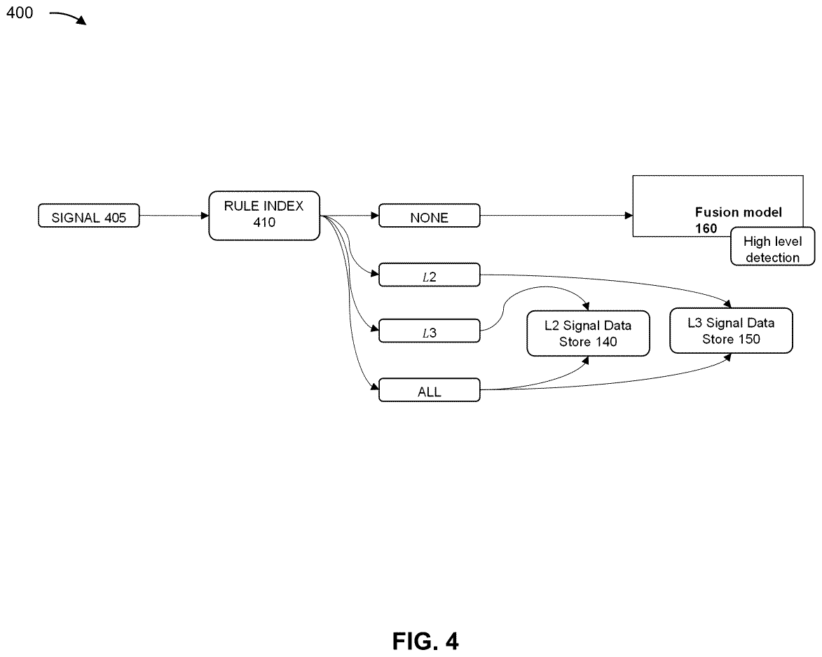

FIG. 4 is a diagram of an example implementation 400 described herein. Implementation 400 may describe a process for routing the signal to a desired destination. As time of level 1 detection module 130 is processing signal 405, a copy of signal 405 will be input into signal bus 135 for transmission to level 2 detection module 145, level 3 detection module 155, or fusion module 160. In some examples, the metadata of the transmission may include: (sᵢ, destination). The variable sᵢ may refer to signal 405. The transmission may be implemented from the result of the analysis by event analyzer 115 using rule index 410. Rule index 410 may include information that may be used by event analyzer 115 to route signal 405. Signal 405 may be routed as follows: 1) make the default destination of signal 405 as NONE; 2) if signal 405 is associated with the level 2 events, mark the destination as L2; 3) if signal 405 is associated with level 3 events, mark the destination as L3; and 4) if items 2) and 3) are satisfied, mark the destination as ALL.

A workflow of signal bus 135 can be implemented as shown in FIG. 4. Signal bus 135 may send the copy of signal 405 to the related destination to make sure that fusion module 160 receives signal 405 without latency.

As indicated above, FIG. 4 is provided as an example.

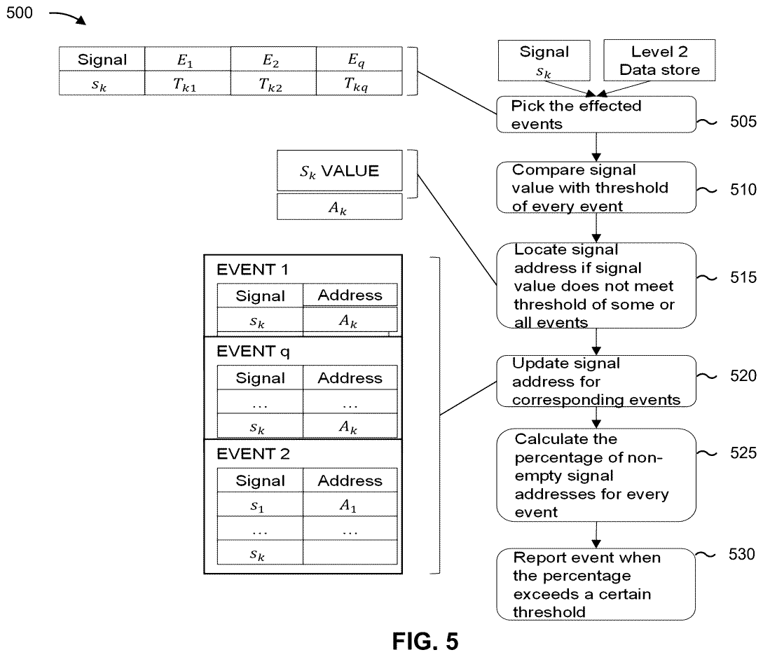

FIG. 5 are diagrams of an example implementation 500 described herein. Implementation 500 may describe a process for detecting events of the second level of complexity. The process may be performed by level 2 detection module 145. As shown in FIG. 5, and by reference number 505, level 2 detection module 145 may pick (or select) effected events. For example, when the signal is provided to L2 signal data store 140, the first check is picking the events which may be affected by this signal. Level 2 detection module 145 may go through every event in L2 signal data store 140. If the rule of the event includes a metric threshold of the signal, then the event is an affected event. In other words, if a value of the signal satisfies the threshold, then event is an affected event.

As shown in FIG. 5, and by block 510, level 2 detection module 145 may compare a signal value of the signal and a threshold of every event of the events affected by the signal. For example, level 2 detection module 145 may determine whether the threshold is reached.

As shown in FIG. 5, and by block 515, level 2 detection module 145 may locate a signal address (of the signal) if the signal value does meet threshold of some or all events. For example, if the signal value meets the threshold of some or all the affected events, level 2 detection module 145 may locate the signal address, of the signal, in a memory associated with system 110.

The address for each event in the L2 signal data store 140 may be obtained when L2 signal data store 140 is built. If a signal for the level 2 events is coming, the signal should be stored somewhere in the memory. The location may be pre-defined during a time when the index is generated because, at that time, level 2 detection module 145 is aware of how many signals are to be collected for level 2 events and the type of each signal. In this case, a type may refer to a measure of urgency associated with a signal. A piece of memory may be located and the signal value may be stored in a location of the piece of memory.

As shown in FIG. 5, and by block 520, level 2 detection module 145 may update the signal address for corresponding events. If the events are updated, level 2 detection module 145 may easily update the index without relocating the value of the signal to another memory location. If new events are introduced for a signal, the index and the link may be updated without reformatting the memory and relocating a value of the signal. In this regard, updating the link may be enough. For example, if a signal value (of a signal) does not meet threshold of events, the event data structures will be updated with the current signal address in memory separately. For example, the address of the value of the signal (or signal value) may be updated in the index. Otherwise, the event data structures will be kept empty address for the signal.

As shown in FIG. 5, and by block 525, level 2 detection module 145 may calculate a percentage of non-empty signal addresses for every event. For example, for each event, when a certain percentage of signal is stored, a certain percentage threshold may be reached.

As shown in FIG. 5, and by block 530, level 2 detection module 145 may report an event when the percentage exceeds a certain. For example, for each event, when a certain percentage of signal is stored, a certain percentage threshold may be reached. Accordingly, level 2 detection module 145 may determine that an event of the second level of complexity has been detected. In this regard, level 2 detection module 145 will report an abnormal occurrence.

The non-empty signal address means one abnormal signal for the event. If the event has a certain percentage of abnormal signals, the event should be reported to the decision-making module. There are many anomaly detection algorithms to set the threshold percentage. Different thresholds for the percentage of abnormal signals can be set for different events.

The above process may not be performed when detecting events of the third level of complexity because calculations are to be performed for level 3 events while a check is performed for level 2 events (e.g., events associated with the second level of complexity). For example, a check is to be performed to determine whether a value meets a threshold. If the value does not meet the threshold, the value will not be stored. With respect to calculations performed for level 2 events, if the value meets the threshold often, performing numerous calculations may have a performance impact on machine 105 and/or on system 110. The numerous calculations may be caused by a frequency at which the signal is refreshed. Additionally, the frequency at which the signal is refreshed may cause numerous input and output operations to be performed. The numerous input and output operations may have a performance impact on machine 105 and/or system 110.

As indicated above, FIG. 5 is provided as an example.

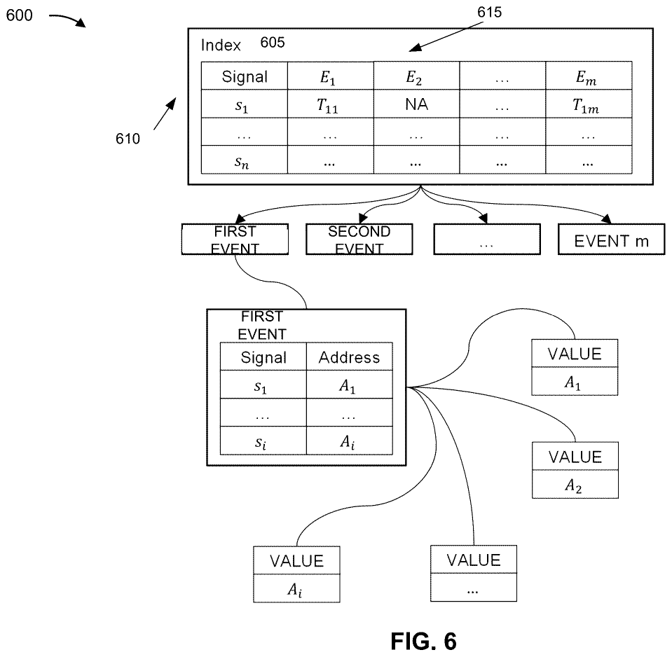

FIG. 6 is a diagram of an example implementation 600 described herein. As shown in FIG. 6, implementation 600 may include L2 signal data store 140. As shown in FIG. 6, L2 signal data store 140 may include an index 605. Index 605 may be generated based on analyzing a user event definition associated with L2 signal data store 140. Indexes may be organized as a table with signals and threshold for all events. L2 signal data store 140 may identify different signals 610 and identify different events 615 associated with each signal. For example, signal S₁ may trigger an event E₁ based on threshold T₁₁ and may trigger event Eₘ based on threshold T₁ₘ.

As shown in FIG. 6, L2 signal data store 140 may include a data structure for different events. For event FIRST EVENT, the data structure includes an address (in the memory) for a signal S₁. The data structure may include the address of a signal if a value of the signal satisfies a threshold. In this case, a value of S₁ satisfies the threshold T₁₁.

As indicated above, FIG. 6 is provided as an example. Other examples may differ from what is described with regard to FIG. 6 of devices shown in FIG. 6 is provided as an example. There may be additional devices (e.g., a large number of devices), fewer devices, different devices, or differently arranged devices than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) shown in FIG. 6 may perform one or more functions described as being performed by another set of devices in FIG. 6.

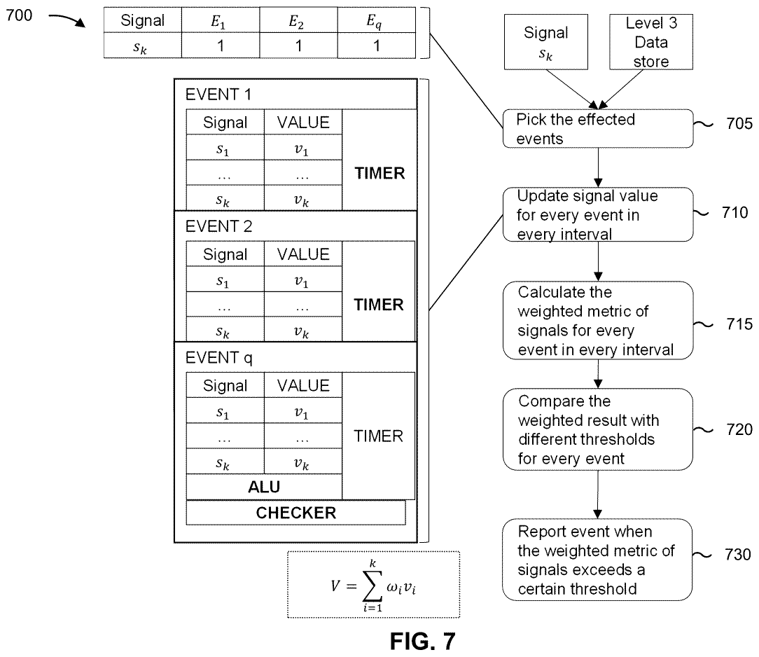

FIG. 7 are diagrams of an example implementation 700 described herein. Implementation 700 may describe a process for detecting events of the second level of complexity. The process may be performed by level 3 detection module 155. As shown in FIG. 7, and by block 705, level 3 detection module 155 may pick (or select) effected events. For example, when the signal is provided to L3 signal data store 150, the first check is picking the events which may be affected by the signal. Level 3 detection module 155 may go through every event in L3 signal data store 150. If the event's rule has weighted metric threshold of the signal, then the event is an affected event. For level 3 events, multiple signals may be used to perform a weighted calculation. A result of the weighted calculation may be compared with the threshold.

As shown in FIG. 7, and by block 710, level 3 detection module 155 may update a signal value for every event in every interval. For example, at the beginning of every interval (time interval), if the signal comes with a new value, then the event data structures will be updated with new value for the signal separately. Otherwise, the event data structures will keep the value from the previous interval for the signal. Different intervals to update signal value can be set for different events.

At the beginning of every interval, if the signal comes with new value, then the event tables will be updated with new value for the signal separately. Otherwise, the event tables will be kept value from the previous interval for the signal. Different intervals to update signal value can be set for different events.

As shown in FIG. 7, and by block 715, level 3 detection module 155 may calculate the weighted metric of signals for every event in every interval. For example, level 3 detection module 155 may calculate a weighted value of the signal (e.g., by multiplying a weight with the value of the signal). Different weights may be selected for different signals.

In some implementations, the value may be calculated using the following formula:

$$V = {\sum }_{i = 1}^{k} {ω}_{i} {v}_{i}$$

Where V refers to the result of the weighted calculation that is used with respect to the threshold, and where v refers to a value of a signal.

As shown in FIG. 7, and by block 720, level 3 detection module 155 may compare the weighted result with different thresholds for every event.

As shown in FIG. 7, and by block 730, level 3 detection module 155 may report an event when the weighted value of the signals exceeds a certain threshold. Different thresholds for abnormal level can be set for one event. If the weighted metric of signals exceeds a certain threshold of event, the corresponding abnormal level will be reported to the decision-making module. There are many anomaly detection algorithms to set the threshold. Different thresholds for abnormal level can be set for different events.

As indicated above, FIG. 7 is provided as an example.

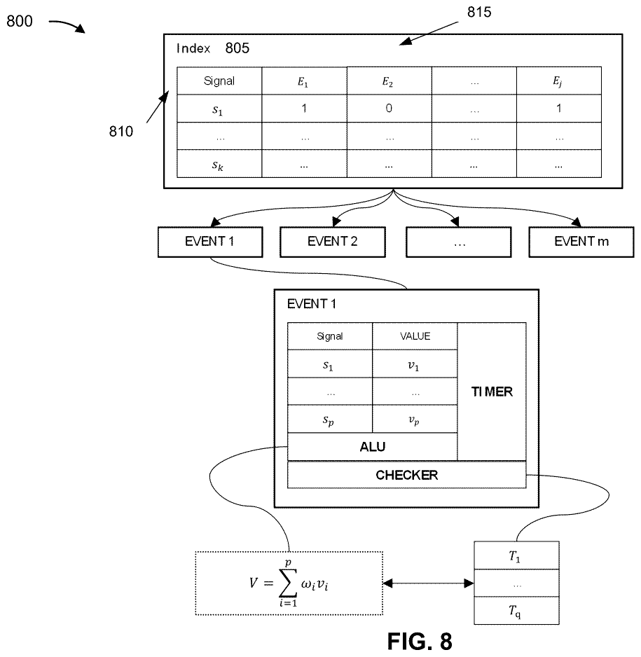

FIG. 8 is a diagram of an example implementation 800 described herein. As shown in FIG. 8, implementation 800 may include L3 signal data store 150. As shown in FIG. 8, L3 signal data store 150 may include an index 805. L3 signal data store 150 may identify different signals 810 and identify different events 815 associated with each signal. For example, signal S₁ may trigger an event E₁ and may trigger event Eⱼ.

As shown in FIG. 8, L3 signal data store 150 may include a data structure for different events. For event EVENT 1, the data structure includes a value v₁ for a signal S₁. The data structure may include the address of a signal if a value of the signal satisfies a threshold. In this case, a value of S1 satisfies the threshold T11. ALU represents ALgorithm Unit, which has the algorithm for the events detection of level 3 events. TIMER is used to control the detection interval. CHECKER is the result comparison to see if the result of ALU is normal or not.

The weighted value (or weighted metric) may be calculated using ALU, TIMER, and CHECKER. For example, for each detection interval which is controlled by TIMER, the ALU will calculate the weighted metric of signals for each event, then CHECKER will compare the weighted result and the pre-defined threshold to know if there is abnormal occur. As explained herein, the weighted metric (or weighted value) may be calculated by multiplying a weight and a value of the signal. This will happen for every event in every detection interval.

As indicated above, FIG. 8 is provided as an example.

FIG. 9 is a diagram of an example computing environment 900 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as event detection code (block) 950. In addition to block 950, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 950, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 950 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 950 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computational resources of public cloud 905 is performed by the computer hardware and/or software of cloud orchestration module 941. The computational resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computational resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

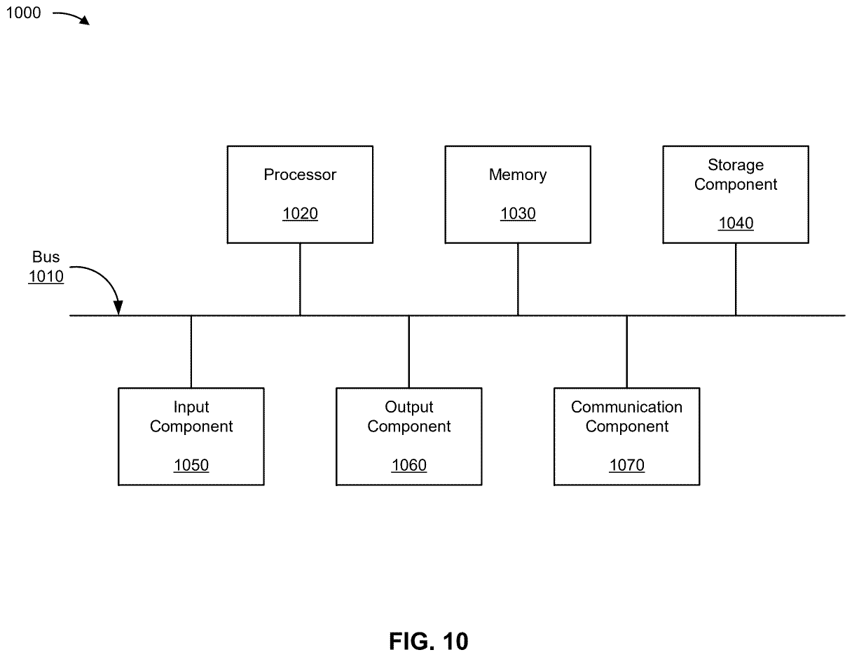

FIG. 10 is a diagram of example components of a device 1000, which may correspond to machine 105. In some implementations, machine 105 may include one or more devices 1000 and/or one or more components of device 1000. As shown in FIG. 10, device 1000 may include a bus 1010, a processor 1020, a memory 1030, a storage component 1040, an input component 1050, an output component 1060, and a communication component 1070.

Bus 1010 includes a component that enables wired and/or wireless communication among the components of device 1000. Processor 1020 includes a central processing unit, a graphics processing unit, a microprocessor, a controller, a microcontroller, a digital signal processor, a field-programmable gate array, an application-specific integrated circuit, and/or another type of processing component. Processor 1020 is implemented in hardware, firmware, or a combination of hardware and software. In some implementations, processor 1020 includes one or more processors capable of being programmed to perform a function. Memory 1030 includes a random access memory, a read only memory, and/or another type of memory (e.g., a flash memory, a magnetic memory, and/or an optical memory).

Storage component 1040 stores information and/or software related to the operation of device 1000. For example, storage component 1040 may include a hard disk drive, a magnetic disk drive, an optical disk drive, a solid state disk drive, a compact disc, a digital versatile disc, and/or another type of non-transitory computer-readable medium. Input component 1050 enables device 1000 to receive input, such as user input and/or sensed inputs. For example, input component 1050 may include a touch screen, a keyboard, a keypad, a mouse, a button, a microphone, a switch, a sensor, a global positioning system component, an accelerometer, a gyroscope, and/or an actuator. Output component 1060 enables device 1000 to provide output, such as via a display, a speaker, and/or one or more light-emitting diodes. Communication component 1070 enables device 1000 to communicate with other devices, such as via a wired connection and/or a wireless connection. For example, communication component 1070 may include a receiver, a transmitter, a transceiver, a modem, a network interface card, and/or an antenna.

Device 1000 may perform one or more processes described herein. For example, a non-transitory computer-readable medium (e.g., memory 1030 and/or storage component 1040) may store a set of instructions (e.g., one or more instructions, code, software code, and/or program code) for execution by processor 1020. Processor 1020 may execute the set of instructions to perform one or more processes described herein. In some implementations, execution of the set of instructions, by one or more processors 1020, causes the one or more processors 1020 and/or the device 1000 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 10 are provided as an example. Device 1000 may include additional components, fewer components, different components, or differently arranged components than those shown in FIG. 10. Additionally, or alternatively, a set of components (e.g., one or more components) of device 1000 may perform one or more functions described as being performed by another set of components of device 1000.

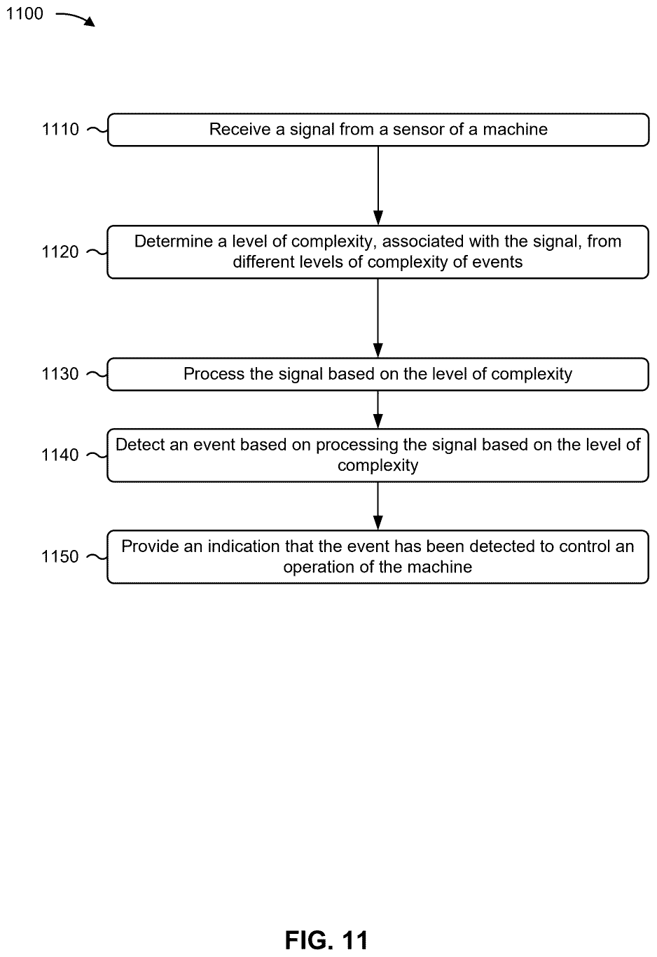

FIG. 11 is a flowchart of an example process 1100 associated with organizing movement of autonomous vehicles. In some implementations, one or more process blocks of FIG. 11 may be performed by a detection module (e.g., level 1 detection module 130, level 2 detection module 145, and/or level 3 detection module 155). In some implementations, one or more process blocks of FIG. 11 may be performed by another device or a group of devices separate from or including the management system, such as a sensor (e.g., sensor 120) and/or a signal bus (e.g., signal bus 135). Additionally, or alternatively, one or more process blocks of FIG. 11 may be performed by one or more components of device 1000, such as processor 1020, memory 1030, storage component 1040, input component 1050, output component 1060, and/or communication component 1070.

As shown in FIG. 11, process 1100 may include receiving a signal from a sensor of a machine (block 1110). For example, the detection module may receive a signal from a sensor of a machine, as described above.

As further shown in FIG. 11, process 1100 may include determining a level of complexity, of events associated with the signal, from different levels of complexity of events occurring during an operation of the machine, wherein the different levels of complexity include: a first level of complexity associated with a single threshold, a second level of complexity associated with a plurality of thresholds, and a third level of complexity associated with weighted signals (block 1120). For example, the detection module may determine a level of complexity, of events associated with the signal, out of a different levels of complexity, wherein the different levels of complexity include: a first level of complexity associated with a single threshold, a second level of complexity associated with a plurality of thresholds, and a third level of complexity associated with weighted signals, as described above. In some implementations, the different levels of complexity include: a first level of complexity associated with a single threshold, a second level of complexity associated with a plurality of thresholds, and a third level of complexity associated with weighted signals.

As further shown in FIG. 11, process 1100 may include processing the signal based on the level of complexity (block 1130). For example, the detection module may process the signal based on the level of complexity, as described above.

As further shown in FIG. 11, process 1100 may include detecting an event based on processing the signal based on the level of complexity (block 1140). For example, the detection module may detect an event based on processing the signal based on the level of complexity, as described above.

As further shown in FIG. 11, process 1100 may include providing an indication that the event has been detected to one or more components of the machine to cause the one or more components to control an operation of the machine (block 1150). For example, the detection module may provide an indication that the event has been detected to one or more components of the machine to cause the one or more components to control an operation of the machine, as described above.

In some implementations, determining the level of complexity associated with the signal comprises determining, using a processor of the sensor, whether the level of complexity is the first level of complexity, providing the signal from the sensor to a signal bus of the machine, and determining, using the signal bus, whether the level of complexity is the first level of complexity or the second level of complexity.

In some implementations, processing the signal based on the level of complexity comprises processing the signal using a first detection module, associated with the processor of the sensor, when the level of complexity is the first level of complexity, processing the signal using a second detection module, associated with the signal bus, when the level of complexity is the second level of complexity, and processing the signal using a third detection module, associated with the signal bus, when the level of complexity is the third level of complexity.

In some implementations, process 1100 includes generating rules identifying the different levels of complexity, wherein the rules are used by the first detection module, the second detection module, and the third detection module.

In some implementations, processing the signal based on the level of complexity comprises determining that the signal is associated with the first level of complexity, determining that the signal satisfies the single threshold, and detecting that an event, associated with the first level of complexity, has occurred based on detecting that the signal satisfies the single threshold.

In some implementations, processing the signal based on the level of complexity comprises determining that the signal is associated with the first level of complexity, determining that the signal does not satisfy a first threshold, determining that the signal satisfies a second threshold after determining that the signal does not satisfy a first threshold, and detecting that an event, associated with the first level of complexity, has occurred based on determining that the signal satisfies the first threshold.

In some implementations, processing the signal based on the level of complexity comprises determining that the signal is associated with the second level of complexity, determining that the signal satisfies a first threshold of the plurality of thresholds, determining that an additional signal satisfies a second threshold of the plurality of thresholds, and detecting that an event, associated with the third level of complexity, has occurred based on determining that the signal satisfies the first threshold and that the additional signal satisfies the second threshold.

In some implementations, processing the signal based on the level of complexity comprises storing information regarding the signal in a data structure based on determining that the signal satisfies the first threshold, determining a portion of entries, of the data structure, that includes values, and detecting that the event has occurred based on the portion of entries that includes values.

In some implementations, processing the signal based on the level of complexity comprises determining that the signal is associated with the third level of complexity, determining that the signal satisfies a first weighted threshold of the plurality of thresholds, determining that an additional signal satisfies a second weighted threshold of the plurality of thresholds, and detecting that an event, associated with the third level of complexity, has occurred based on determining that the signal satisfies the first weighted threshold and that the additional signal satisfies the second weighted threshold.

Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving a signal from a sensor of a machine;
determining a level of complexity, associated with the signal, from different levels of complexity of events occurring during an operation of the machine,
wherein the different levels of complexity include:
a first level of complexity associated with a single threshold,
a second level of complexity associated with a plurality of thresholds, and
a third level of complexity associated with weighted signals;
processing the signal based on the level of complexity;
detecting an event based on processing the signal based on the level of complexity; and
providing an indication that the event has been detected to one or more components of the machine to cause the one or more components to control the operation of the machine.

2. The method of claim 1, wherein determining the level of complexity associated with the signal comprises:
determining, using a processor of the sensor, whether the level of complexity is the first level of complexity;
providing the signal from the sensor to a signal bus of the machine; and
determining, using the signal bus, whether the level of complexity is the first level of complexity or the second level of complexity.

3. The method of claim 2, wherein processing the signal based on the level of complexity comprises:
processing the signal using a first detection module, associated with the processor of the sensor, when the level of complexity is the first level of complexity;
processing the signal using a second detection module, associated with the signal bus, when the level of complexity is the second level of complexity; and
processing the signal using a third detection module, associated with the signal bus, when the level of complexity is the third level of complexity.

4. The method of claim 3, further comprising:
generating rules identifying the different levels of complexity,
wherein the rules are used by the first detection module, the second detection module, and the third detection module.

5. The method of claim 1, wherein processing the signal based on the level of complexity comprises:
determining that the signal is associated with the first level of complexity;
determining that the signal satisfies the single threshold; and
detecting that the event, associated with the first level of complexity, has occurred based on detecting that the signal satisfies the single threshold.

6. The method of claim 5, wherein processing the signal based on the level of complexity comprises:
determining that the signal is associated with the first level of complexity;
determining that the signal does not satisfy a first threshold;
determining that the signal satisfies a second threshold after determining that the signal does not satisfy the first threshold; and
detecting that an event, associated with the first level of complexity, has occurred based on determining that the signal satisfies the first threshold.

7. The method of claim 1, wherein processing the signal based on the level of complexity comprises:
determining that the signal is associated with the second level of complexity;
determining that the signal satisfies a first threshold of the plurality of thresholds;
determining that an additional signal satisfies a second threshold of the plurality of thresholds; and
detecting that an event, associated with the third level of complexity, has occurred based on determining that the signal satisfies the first threshold and that the additional signal satisfies the second threshold.

8. The method of claim 7, wherein processing the signal based on the level of complexity comprises:
storing information regarding the signal in a data structure based on determining that the signal satisfies the first threshold;
determining a portion of entries, of the data structure, that includes values; and
detecting that the event has occurred based on the portion of entries that includes the values.

9. The method of claim 1, wherein processing the signal based on the level of complexity comprises:
determining that the signal is associated with the third level of complexity;
determining that the signal satisfies a first weighted threshold of the plurality of thresholds;
determining that an additional signal satisfies a second weighted threshold of the plurality of thresholds; and
detecting that an event, associated with the third level of complexity, has occurred based on determining that the signal satisfies the first weighted threshold and that the additional signal satisfies the second weighted threshold.

10. A system comprising:
an event analyzer to generate information regarding different levels of complexity of different events detected during an operation of a vehicle,
wherein the different levels of complexity include:
a first level of complexity associated with a single threshold,
a second level of complexity associated with a plurality of thresholds, and
a third level of complexity associated with weighted signals;
a sensor to:
generate a signal,
determine whether a level of complexity of events, associated with the signal, is the first level of complexity;
process the signal based on the first level of complexity to determine whether a first event associated with the first level of complexity is detected; and
a signal bus to:
determine whether the level of complexity is the second level of complexity or the third level of complexity, and
provide the signal to be processed based on:
the second level of complexity to determine whether a second event associated with the second level of complexity is detected, or
the third level of complexity to determine whether a third event associated with the third level of complexity is detected.

11. The system of claim 10, wherein the sensor includes a first detection module to process the signal based on the first level of complexity to determine whether the first event is detected, and
wherein the system further comprises:
a second detection module to process the signal based on the second level of complexity to determine whether the second event is detected; and
a third detection module to process the signal based on the third level of complexity to determine whether the third event is detected.

12. The system of claim 11, wherein the first detection module is to provide an indication, that the first event has been detected, to one or more components of the vehicle to cause the one or more components to control the operation of the vehicle, and
wherein the event analyzer, the sensor, the signal bus, the second detection module, and the third detection module are included in the vehicle.

13. The system of claim 11, wherein the second detection module is to provide an indication, that the second event has been detected, to one or more components of the vehicle to cause the one or more components to control an operation of the vehicle, and
wherein the event analyzer, the sensor, the signal bus, the second detection module, and the third detection module are included in the vehicle.

14. The system of claim 11, wherein the third detection module is to provide an indication, that the third event has been detected, to one or more components of the vehicle to cause the one or more components to control an operation of the vehicle, and
wherein the event analyzer, the sensor, the signal bus, the second detection module, and the third detection module are included in the vehicle.

15. The system of claim 11, wherein the third detection module is to:
determine that the signal is associated with the third level of complexity;
determine that the signal satisfies a first weighted threshold of the plurality of thresholds;
determine that an additional signal satisfies a second weighted threshold of the plurality of thresholds; and
detect that the third event has occurred based on determining that the signal satisfies the first weighted threshold and that the additional signal satisfies the second weighted threshold.

16. A computer program product comprising:
one or more computer-readable storage media; and
program instructions stored on the one or more computer readable storage media to perform comprising:
receiving a signal from a sensor of a machine;
determining a level of complexity, of events associated with the signal, from different levels of complexity of events occurring during an operation of the machine,
wherein the different levels of complexity include:
a first level of complexity associated with a single threshold,
a second level of complexity associated with a plurality of thresholds, and
a third level of complexity associated with weighted signals;
processing the signal based on the level of complexity;
detecting an event based on processing the signal based on the level of complexity; and
providing an indication that the event has been detected to one or more components of the machine to cause the one or more components to control the operation of the machine.

17. The computer program product of claim 16, wherein determining the level of complexity associated with the signal comprises:
determining, using a first filter of a processor of the sensor, whether the level of complexity is the first level of complexity;
providing the signal from the sensor to a signal bus of the machine; and
determining, using a second filter of the signal bus, whether the level of complexity is the first level of complexity or the second level of complexity.

18. The computer program product of claim 17, wherein determining the level of complexity associated with the signal comprises:
processing the signal using a first detection module, associated with the processor of the sensor, when the level of complexity is the first level of complexity;
processing the signal using a second detection module, associated with the signal bus, when the level of complexity is the second level of complexity; and
processing the signal using a third detection module, associated with the signal bus, when the level of complexity is the third level of complexity.

19. The computer program product of claim 18, wherein the operations further comprise:
generating rules identifying the different levels of complexity,
wherein the rules are used by the first detection module, the second detection module, and the third detection module.

20. The computer program product of claim 18, wherein the operations further comprise:
determining that the signal is associated with the second level of complexity;
determining that the signal satisfies a first threshold of the plurality of thresholds;
determining that an additional signal satisfies a second threshold of the plurality of thresholds; and
detecting that an event, associated with the third level of complexity, has occurred based on determining that the signal satisfies the first threshold and that the additional signal satisfies the second threshold.
